(19) United States
(12) Patent Application Publication
(10) Pub. No.: US 2006/0196974 A1
(43) Pub. Date: Sep. 7, 2006

(54) Fuel injector having a gradually restricted drain passageway

(75) Inventors: Mingyong Chen, Peoria, IL (US); Dennis H. Gibson, Chillicothe, IL (US); Mark F. Sommars, Sparland, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/067,745

(22) Filed: Mar. 1, 2005

(51) Int. Cl. F02M 63/00

(52) U.S. Cl. 239/533.2

(57) ABSTRACT

A fuel injector for a work machine is disclosed. The fuel injector has a nozzle member with at least one orifice and a needle valve element having a tip end and a base end. The needle valve element is axially movable to selectively allow and block fuel flow through the at least one orifice with the tip end. The fuel injector also has a control chamber in communication with the base end of the needle valve element. The control chamber has a sidewall portion radially disposed relative to the axial movement of the needle valve element. The fuel injector further has a port disposed in the sidewall portion of the control chamber and at least one passageway in communication with the port to selectively drain fuel from the control chamber, thereby initiating movement of the needle valve element.

### TECHNICAL FIELD

The present disclosure is directed to a fuel injector and, more particularly, to a fuel injector having a gradually restricted drain passageway.

### BACKGROUND

Common rail fuel systems typically employ multiple closed-nozzle fuel injectors to inject high pressure fuel into the combustion chambers of an engine. Each of these fuel injectors may include a nozzle assembly having a cylindrical bore with a nozzle supply passageway and a nozzle outlet. A needle check valve may be reciprocatingly disposed within the cylindrical bore and biased toward a closed position where the nozzle outlet is blocked. To inject fuel, the needle check valve may be selectively moved to open the nozzle outlet, thereby allowing high pressure fuel to flow from the nozzle supply passageway into the combustion chamber. For example, a control chamber in fluid communication with a base of the needle check valve may be selectively drained of pressurized fluid to bias the needle check valve toward the open position.

One such device is described in U.S. Pat. No. 5,671,715 (the '715 patent) issued to Tsuzuki et al. on Sep. 30, 1997. The '715 patent describes a fuel injection device having an injection hole. A needle valve is movable between a first and second position to open and close the injection hole. The fuel injection device also includes a back pressure chamber vented to a drain via a two-way solenoid valve. The needle is movable between the first and second positions depending on the pressure in the back pressure chamber.

Although the fuel injection device of the '715 patent may adequately supply pressurized fuel to an engine, it may be problematic. For example, during movement of the needle valve of the '715 patent, an upper end surface of the needle valve is allowed to abut a lower end surface of the back pressure chamber. If the needle valve is moving at a high enough speed when the abutment occurs, it may be possible for the needle valve to bounce away from the lower end surface causing an unpredictable disruption in the injection of fuel. This inconsistent and unpredictable injector performance could change fuel delivery characteristics significantly enough to affect performance of the engine.

In addition, the abutment of the upper and lower surfaces of the needle valve and back pressure chamber described in the '715 patent may reduce component life of the fuel injection device and increase noise pollution. In particular, because the upper and lower surfaces make contact, wear between the two surfaces may increase, possibly resulting in premature failure. Further, debris may be generated from the contact of the upper and lower surfaces that could contaminate other components of the fuel system of the '715 patent. Moreover, the abutment between the upper and lower surfaces increases vibration and noise of the fuel system.

The fuel injector of the present disclosure solves one or more of the problems set forth above.

### SUMMARY OF THE INVENTION

One aspect of the present disclosure is directed to a fuel injector. The fuel injector includes a nozzle member having at least one orifice and a needle valve element having a tip end and a base end. The needle valve element is axially movable to selectively allow and block fuel flow through the at least one orifice with the tip end. The fuel injector also includes a control chamber in communication with the base end of the needle valve element. The control chamber has a sidewall portion radially disposed relative to the axial movement of the needle valve element. The fuel injector also includes a port disposed in the sidewall portion of the control chamber and at least one passageway in communication with the port to selectively drain fuel from the control chamber, thereby initiating movement of the needle valve element.

Another aspect of the present disclosure is directed to a method of injecting fuel into a combustion chamber of an engine. The method includes directing pressurized fuel to at least one orifice of a nozzle member and selectively moving a needle valve element to allow and block fuel flow through the at least one orifice with a tip end of the needle valve element. The method also includes selectively draining fuel from a base end of the needle valve element through a port in a sidewall portion of the control chamber to initiate axial movement of the needle valve element. The sidewall portion is disposed radially relative to the axial movement of the needle valve element.

### BRIEF DESCRIPTION OF THE DRAWINGS

FIG. 1 is a schematic and diagrammatic illustration of an exemplary disclosed fuel system; and

FIG. 2 is a cross-sectional illustration of an exemplary disclosed fuel injector for the fuel system of FIG. 1.

### DETAILED DESCRIPTION

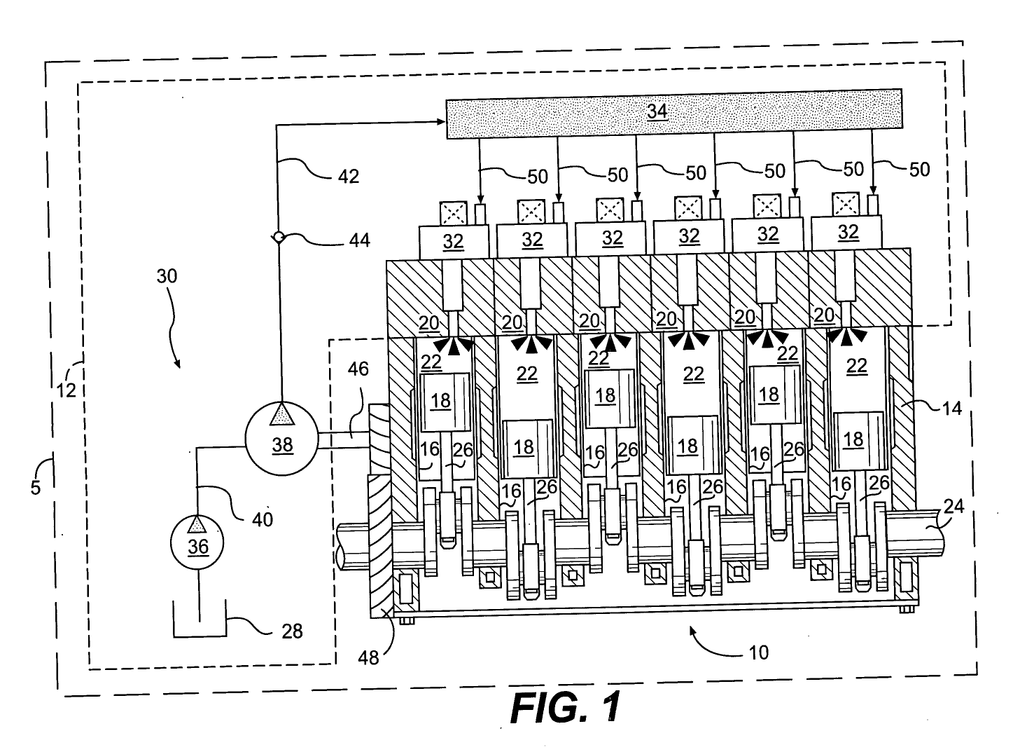

FIG. 1 illustrates a work machine 5 having an engine 10 and an exemplary embodiment of a fuel system 12. Work machine 5 may be a fixed or mobile machine that performs some type of operation associated with an industry such as mining, construction, farming, power generation, transportation, or any other industry known in the art. For example, work machine 5 may be an earth moving machine, a generator set, a pump, or any other suitable operation-performing work machine.

For the purposes of this disclosure, engine 10 is depicted and described as a four-stroke diesel engine. One skilled in the art will recognize, however, that engine 10 may be any other type of internal combustion engine such as, for example, a gasoline or a gaseous fuel-powered engine. Engine 10 may include an engine block 14 that defines a plurality of cylinders 16, a piston 18 slidably disposed within each cylinder 16, and a cylinder head 20 associated with each cylinder 16.

Cylinder 16, piston 18, and cylinder head 20 may form a combustion chamber 22. In the illustrated embodiment, engine 10 includes six combustion chambers 22. However, it is contemplated that engine 10 may include a greater or lesser number of combustion chambers 22 and that combustion chambers 22 may be disposed in an “in-line” configuration, a “V” configuration, or any other suitable configuration.

As also shown in FIG. 1, engine 10 may include a crankshaft 24 that is rotatably disposed within engine block 14. A connecting rod 26 may connect each piston 18 to crankshaft 24 so that a sliding motion of piston 18 within each respective cylinder 16 results in a rotation of crankshaft 24. Similarly, a rotation of crankshaft 24 may result in a sliding motion of piston 18.

Fuel system 12 may include components that cooperate to deliver injections of pressurized fuel into each combustion chamber 22. Specifically, fuel system 12 may include a tank 28 configured to hold a supply of fuel, and a fuel pumping arrangement 30 configured to pressurize the fuel and direct the pressurized fuel to a plurality of fuel injectors 32 by way of a common rail 34.

Fuel pumping arrangement 30 may include one or more pumping devices that function to increase the pressure of the fuel and direct one or more pressurized streams of fuel to common rail 34. In one example, fuel pumping arrangement 30 includes a low pressure source 36 and a high pressure source 38 disposed in series and fluidly connected by way of a fuel line 40. Low pressure source 36 may be a transfer pump configured to provide low pressure feed to high pressure source 38. High pressure source 38 may be configured to receive the low pressure feed and to increase the pressure of the fuel to the range of about 30-300 MPa. High pressure source 38 may be connected to common rail 34 by way of a fuel line 42. A check valve 44 may be disposed within fuel line 42 to provide for one-directional flow of fuel from fuel pumping arrangement 30 to common rail 34.

One or both of low pressure and high pressure sources 36, 38 may be operably connected to engine 10 and driven by crankshaft 24. Low and/or high pressure sources 36, 38 may be connected with crankshaft 24 in any manner readily apparent to one skilled in the art where a rotation of crankshaft 24 will result in a corresponding rotation of a pump drive shaft. For example, a pump driveshaft 46 of high pressure source 38 is shown in FIG. 1 as being connected to crankshaft 24 through a gear train 48. It is contemplated, however, that one or both of low and high pressure sources 36, 38 may alternatively be driven electrically, hydraulically, pneumatically, or in any other appropriate manner.

Fuel injectors 32 may be disposed within cylinder heads 20 and connected to common rail 34 by way of a plurality of fuel lines 50. Each fuel injector 32 may be operable to inject an amount of pressurized fuel into an associated combustion chamber 22 at predetermined timings, fuel pressures, and fuel flow rates. The timing of fuel injection into combustion chamber 22 may be synchronized with the motion of piston 18. For example, fuel may be injected as piston 18 nears a top-dead-center position in a compression stroke to allow for compression-ignited-combustion of the injected fuel. Alternatively, fuel may be injected as piston 18 begins the compression stroke heading towards a top-dead-center position for homogenous charge compression ignition operation. Fuel may also be injected as piston 18 is moving from a top-dead-center position towards a bottom-dead-center position during an expansion stroke for a late post injection to create a reducing atmosphere for aftertreatment regeneration.

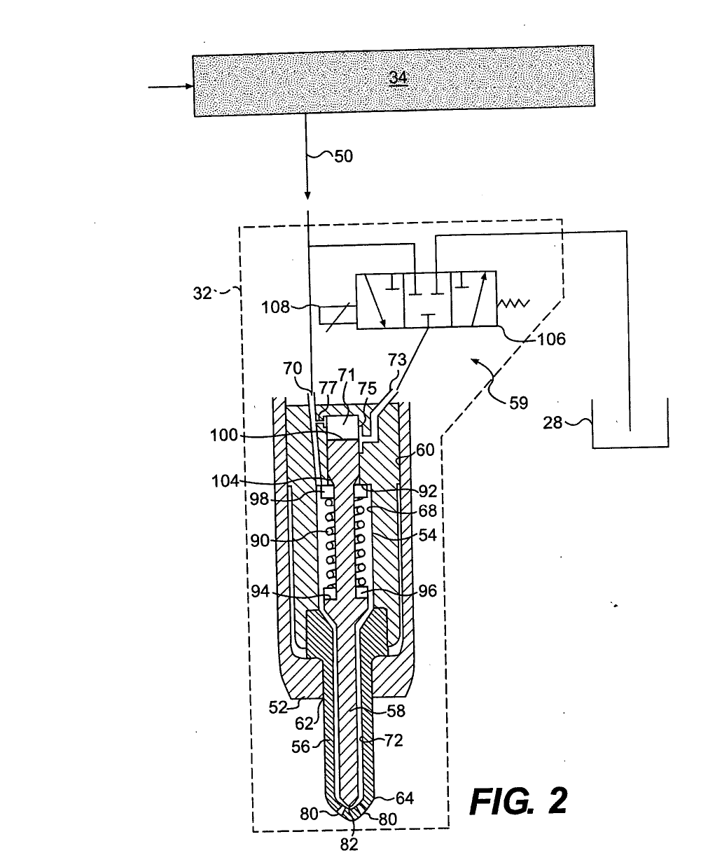

As illustrated in FIG. 2, each fuel injector 32 may be a closed nozzle unit fuel injector. Specifically, each fuel injector 32 may include an injector body 52 housing a guide 54, a nozzle member 56, a needle valve element 58, and a solenoid actuator 59.

Injector body 52 may be a cylindrical member configured for assembly within cylinder head 20. Injector body 52 may have a central bore 60 for receiving guide 54 and nozzle member 56, and an opening 62 through which a tip end 64 of nozzle member 56 may protrude. A sealing member such as, for example, an o-ring (not shown) may be disposed between guide 54 and nozzle member 56 to restrict fuel leakage from fuel injector 32.

Guide 54 may also be a cylindrical member having a central bore 68 configured to receive needle valve element 58, and a control chamber 71. Central bore 68 may act as a pressure chamber, holding pressurized fuel that is continuously supplied from a fuel supply passageway 70. During injection, the pressurized fuel from fuel line 50 may be allowed to flow through fuel supply passageway 70 and central bore 68 to nozzle member 56.

Control chamber 71 may be selectively drained of or supplied with pressurized fuel to control motion of needle valve element 58. Specifically, a control passageway 73 may fluidly connect a port 75 associated with control chamber 71, and solenoid actuator 59. Port 75 may be disposed within a side wall of control chamber 71 that is radially disposed relative to axial movement of needle valve element 58. Port 75 may have a diameter greater than a diameter of control passageway 73 to allow for a gradually blocking of port 75 that increases flow restriction through port 75 into control passageway 73. Control chamber 71 may also be continuously supplied with pressurized fluid via a supply passageway 77 that is communication with fuel supply passageway 70. Port 75 may be located axially between the opening of fuel supply passageway 70 into control chamber 71, and nozzle member 56. A diameter of supply passageway 77 may be less than a diameter of control passageway 73 to allow for a pressure drop within control chamber 71 when control passageway 73 is drained of pressurized fuel.

Nozzle member 56 may likewise embody a cylindrical member having a central bore 72 that is configured to receive needle valve element 58. Nozzle member 56 may also include one or more orifices 80 to allow the pressurized fuel from central bore 68 into combustion chambers 22 of engine 10.

Needle valve element 58 may be an elongated cylindrical member that is slidingly disposed within housing guide 54 and nozzle member 56. Needle valve element 58 may be axially movable between a first position at which a tip end 82 of needle valve element 58 blocks a flow of fuel through orifices 80, and a second position at which orifices 80 are open to allow a flow of fuel into combustion chamber 22.

Needle valve element 58 may be normally biased toward the first position. In particular, as seen in FIG. 2, each fuel injector 32 may include a spring 90 disposed between a stop 92 of guide 54 and a seating surface 94 of needle valve element 58 to axially bias tip end 82 toward the orifice-blocking position. A first spacer 96 may be disposed between spring 90 and stop 92, and a second spacer 98 may be disposed between spring 90 and seating surface 94 to reduce wear of the components within fuel injector 32.

Needle valve element 58 may have multiple driving hydraulic surfaces. In particular, needle valve element 58 may include a hydraulic surface 100 tending to drive needle valve element 58 toward the first or orifice-blocking position when acted upon by pressurized fuel, and a hydraulic surface 104 that tends to oppose the bias of spring 90 and drive needle valve element 58 in the opposite direction toward the second or orifice-opening position.

Solenoid actuator 59 may be disposed opposite tip end 82 of needle valve element 58 to control the motion of needle valve element 58. In particular solenoid actuator 59 may include a three position proportional valve element 106 disposed within control passageway 73 between control chamber 71 and tank 28. Proportional valve element 106 may be spring biased and solenoid actuated to move between a first position at which fuel is allowed to flow from control chamber 71 to tank 28, a second position at which pressurized fuel from fuel line 50 flows through control passageway 73 into control chamber 71, and a third position at which fuel flow through control passageway 73 is blocked. The position of proportional valve element 106 between the first, second, and third positions may determine a flow rate of the fuel through control passageway 73, as well as the flow direction. Proportional valve element 106 may be movable between the first, second, and third positions in response to an electric current applied to a solenoid 108 associated with proportional valve element 106. It is contemplated that proportional valve element 106 may alternatively be hydraulically actuated, mechanically actuated, pneumatically actuated, or actuated in any other suitable manner. It is further contemplated that proportional valve element may be a two-position valve element that is movable between only a control chamber draining position and a control chamber filling position.

### INDUSTRIAL APPLICABILITY

The fuel injector of the present disclosure has wide applications in a variety of engine types including, for example, diesel engines, gasoline engines, and gaseous fuel-powered engines. The disclosed fuel injector may be implemented into any engine that utilizes a pressurizing fuel system wherein it may be advantageous to provide consistent predictable injections of fuel, while minimizing needle valve wear. The operation of fuel injector 32 will now be explained.

Needle valve element 58 may be moved by an imbalance of force generated by fluid pressure. For example, when needle valve element 58 is in the first or orifice-blocking position, pressurized fuel from fuel supply passageway 70 may flow into control chamber 71 to act on hydraulic surface 100. Simultaneously, pressurized fuel from fuel supply passageway 70 may flow into central bore 68 in anticipation of injection. The force of spring 90 combined with the hydraulic force created at hydraulic surface 100 may be greater than an opposing force created at hydraulic surface 104 thereby causing needle valve element 58 to remain in the first position to restrict fuel flow through orifices 80. To open orifices 80 and inject the pressurized fuel from central bore 68 into combustion chamber 22, solenoid actuator 59 may move proportional valve element 106 to selectively drain the pressurized fuel away from control chamber 71 and hydraulic surface 100. This decrease in pressure acting on hydraulic surface 100 allows the opposing force acting across hydraulic surface 104 to overcome the biasing force of spring 90, thereby moving needle valve element 58 toward the orifice-opening position.

During the orifice-opening movement of needle valve element 58, it is possible for significant momentum to develop. If movement of needle valve element 58 is not sufficiently dampened, it may be possible for the base end of needle valve element 58 to strike against a lower axial surface of control chamber 71, thereby disrupting the flow of pressurized fuel through orifices 80 into combustion chamber 22.

Port 75 has been positioned to dampen the orifice-opening movement of needle valve element 58. In particular, because port 75 is located within a radial side wall of control chamber 71, port 75 is increasingly blocked by the base end of needle valve element 58, thereby gradually restricting the flow of fuel from control chamber 71 through control passageway 73 to tank 28. Eventually, the flow of fuel is restricted to such a point during movement of needle valve element 58 that the pressure of the fuel remaining within control chamber 71 is sufficient to offset the momentum of needle valve element 58, slowing and eventually stopping the movement of needle valve element 58 before needle valve element 58 contacts the lower axial surface of control chamber 71. In particular, the pressure build up within control chamber 71 is sufficient to always maintain a distance between the base end of needle valve element 58 and the lower axial surface of control chamber 71. Because port 75 is never completely blocked, the pressure buildup within control chamber 71 is insufficient to reverse the movement direction of needle valve element 58 and cause a change in fuel delivery characteristics. Further, because needle valve element 58 and the lower axial surface of control chamber 71 do not make contact during operation of fuel injector 32, wear and noise levels of fuel system 12 are reduced, while component life of fuel system 12 is increased.

It will be apparent to those skilled in the art that various modifications and variations can be made to the fuel injector of the present disclosure without departing from the scope of the disclosure. Other embodiments will be apparent to those skilled in the art from consideration of the specification and practice of the fuel injector disclosed herein. It is intended that the specification and examples be considered as exemplary only, with a true scope of the invention being indicated by the following claims and their equivalents.

What is claimed is:

1. A fuel injector, comprising:
nozzle member having at least one orifice;
a needle valve element having a tip end and a base end, the needle valve element axially movable to selectively allow and block fuel flow through the at least one orifice with the tip end;
a control chamber in communication with the base end of the needle valve element, the control chamber having a sidewall portion radially disposed relative to the axial movement of the needle valve element;
a port disposed in the sidewall portion of the control chamber; and
at least one passageway in communication with the port to selectively drain fuel from the control chamber, thereby initiating movement of the needle valve element.

2. The fuel injector of claim 1, wherein draining fuel from the control chamber initiates movement of the needle valve element in an orifice-opening direction.

3. The fuel injector of claim 1, wherein a diameter of the port is larger than a diameter of the at least one passageway.

4. The fuel injector of claim 1, wherein the port is at least partially blocked by the needle valve element during movement of the needle valve element to restrict fuel flow from the control chamber, thereby slowing the movement of the needle valve element.

5. The fuel injector of claim 4, wherein the port always remains at least partially open.

6. The fuel injector of claim 1, wherein the control chamber has an end surface and a distance is always maintained between the base of the needle valve element and the end surface.

7. The fuel injector of claim 1, further including a supply passageway configured to continuously direct pressurized fuel to the control chamber during operation of the fuel injector, wherein the port is located between an opening of the supply passageway into the control chamber and the nozzle member relative to the axial movement of the needle valve element.

8. The fuel injector of claim 7, wherein the at least one passageway is selectively communicated with a supply of pressurized fuel to direct pressurized fuel into the control chamber.

9. The fuel injector of claim 8, wherein the directing of pressurized fuel into the control chamber via the at least one passageway initiates movement of the needle valve element in an orifice-closing direction.

10. The fuel injector of claim 1, further including:
a pressure chamber in communication with the tip end of the needle valve element; and
a supply passageway in communication with the pressure chamber and configured to continuously communicate pressurized fuel with the pressure chamber during operation of the fuel injector.

11. A method of injecting fuel into a combustion chamber of an engine, the method comprising:
directing pressurized fuel to at least one orifice of a nozzle member;
selectively moving a needle valve element to allow and block fuel flow through the at least one orifice with a tip end of the needle valve element;
and
selectively draining fuel from a base end of the needle valve element through a port in a sidewall portion of the control chamber to initiate axial movement of the needle valve element, the sidewall portion being disposed radially relative to the axial movement of the needle valve element.

12. The method of claim 11, wherein draining fuel from the control chamber initiates movement of the needle valve element in an orifice-opening direction

13. The method of claim 11, wherein:
draining fuel through the port includes directing fuel from the control chamber through the port to a drain passageway; and
a diameter of the drain passageway is less than a diameter of the port.

14. The method of claim 11, further including at least partially blocking the port with the needle valve element during movement of the needle valve element to restrict fuel flow from the control chamber, thereby slowing the movement of the needle valve element.

15. The method of claim 14, wherein the port always remains at least partially open.

16. The method of claim 11, further including preventing the needle valve element from contacting an end surface of the control chamber.

17. The method of claim 11, further including continuously directing pressurized fuel to the control chamber via a supply passageway during operation of the fuel injector.

18. The method of claim 11, further including selectively directing pressurized fuel to the control chamber via the port to initiate movement of the needle valve element in an orifice-closing direction.

19. The method of claim 11, further including continuously directing pressurized fuel to a pressure chamber associated with the at least one orifice during operation of the fuel injector.

20. A work machine, comprising:
an engine configured to generate a power output, the engine having at least one combustion chamber; and
a fuel injector configured to inject pressurized fuel into the at least one combustion chamber of the engine, the fuel injector comprising:
nozzle member having at least one orifice;
a needle valve element having a tip end and a base end, the needle valve element axially movable to selectively allow and block fuel flow through the at least one orifice with the tip end;
a control chamber in communication with the base end of the needle valve element, the control chamber having a sidewall portion radially disposed relative to the axial movement of the needle valve element;
a port disposed in the sidewall portion of the control chamber; and
at least one passageway in communication with the port to selectively drain fuel from the control chamber, thereby initiating movement of the needle valve element in an orifice-opening direction.

21. The work machine of claim 20, wherein a diameter of the port is larger than a diameter of the at least one passageway.

22. The work machine of claim 20, wherein:
the port of the at least one passageway is at least partially blocked by the needle valve element during movement of the needle valve element to restrict fuel flow from the control chamber, thereby slowing the movement of the needle valve element; and
the port always remains at least partially open.

23. The work machine of claim 20, wherein the control chamber has an end surface and a distance is always maintained between the base of the needle valve element and the end surface.

24. The work machine of claim 20, further including a supply passageway configured to continuously direct pressurized fuel to the control chamber during operation of the fuel injector, wherein the port is located between an opening of the supply passageway into the control chamber and the nozzle member relative to the axial movement of the needle valve element.

25. The work machine of claim 24, wherein the at least one passageway is selectively communicated with a supply of pressurized fuel to direct pressurized fuel to the control chamber to initiate movement of the needle valve element in an orifice-closing direction.

26. The work machine of claim 20, further including:
a pressure chamber in communication with the tip end of the needle valve element; and
a supply passageway in communication with the pressure chamber and configured to continuously communicate pressurized fuel with the pressure chamber during operation of the fuel injector.
